(19) United States
(12) Patent Application Publication
(10) Pub. No.: US 2010/0182719 A1
(43) Pub. Date: Jul. 22, 2010

(54) LUBRICANT AGENT AND MAGNETIC STORAGE DEVICE

(75) Inventor: Keiji WATANABE, Atsugi-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/691,398

(22) Filed: Jan. 21, 2010

(30) Foreign Application Priority Data
Jan. 21, 2009 (JP) 2009-011368

(51) Int. Cl. G11B 21/02; C08G 65/00; G11B 5/33

(52) U.S. Cl. 360/75; 528/401; 428/810; G9B/21.003

(57) ABSTRACT

According to one embodiment, a lubricant agent comprises a fluorine polymer represented as follows:

R¹—O—(R³O)l(R⁴O)m(R⁵O)n(R⁶O)o(R⁷)p-R²

where, R¹ is a perfluoroalkyl group of C1 to C10, R² is an organic group including at least one of three or more polar groups and carbon-carbon pi bonding, R³, R⁴, R⁵, and R⁶ are perfluoroalkylene groups of C1 to C4, respectively, R⁷ is an alkylene group or the perfluoroalkylene group of C1 to C10, and l, m, n, o, and p each indicate zero or a positive integer and do not concurrently indicate zero.

### CROSS-REFERENCE TO RELATED APPLICATIONS

This application is based upon and claims the benefit of priority from Japanese Patent Application No. 2009-011368, filed Jan. 21, 2009, the entire contents of which are incorporated herein by reference.

### BACKGROUND

1. Field

One embodiment of the invention relates to a lubricant agent for a magnetic storage device, and more specifically, to a lubricant agent and a magnetic storage device coated with the lubricant agent.

2. Description of the Related Art

In the magnetic storage device, a head slider with a recording conversion element (hereinafter, simply referred to as “magnetic head”) reads or writes information while floating above a hard disk, which is a magnetic recording medium. The distance between the magnetic head and a magnetic layer for recording (writing) or reproducing (reading) magnetic information on the hard disk is referred to as a magnetic spacing. The narrower magnetic spacing achieves higher recording density.

High information transfer rate requires increased hard disk revolutions. Lower floating and high-speed rotation are advancing with recent enhancement in recording density and transfer rate. The floating height of the magnetic head is about 10 nm, and the rotation speed is from about a few K to 15 K revolution per minute (rpm).

The lubricant agent is generally applied in a thickness of about 1 to 2 nm on the hard disk and the head slider in the magnetic storage device to enhance the reliability. The perfluoropolyether having low surface free energy is generally used for the lubricant agent that reduces wear when the magnetic head contacts the hard disk, thereby preventing the occurrence of failure.

The film thickness of the lubricant agent is about 10% of the head floating height, which is a non-negligible thickness with respect to the magnetic spacing. To enhance the recording density, it is necessary to reduce the film thickness of the lubricant agent and to reduce the magnetic spacing. Reference may be had to, for example, X. Ma et al., “Contribution of lubricant thickness to head-media spacing” IEEE Trans. Magn. Vol. 37, pp 1824-1826.

The film thickness of the currently applied lubricant agent corresponds to about molecular one layer, but is actually at a high position since a portion in the middle of the molecule sometimes separates from the coated surface, and some molecules may contact the magnetic head. The separated lubricant agent that aggregates or attaches to the magnetic head degrades the floating property and the sliding feature.

The lubricant agent generally has polar groups at the end. For example, in Fomblin ZDOL, Z-TETRAOL (product name, manufactured by Solvaysolexis Co.), i.e., typical lubricant agent, one or two hydroxyl groups are introduced to the end group at both ends. In the case of such lubricant agent, it is desired that both ends are adsorbed to the magnetic recording medium (specifically, protective film of the magnetic recording medium). If one or both sides are desorbed, the freed adsorption group may adsorb to the magnetic head side or may become the core and form an aggregation of the lubricant agent, which degrades the floating property and the sliding feature.

FIGS. 4A and 4B are schematic views for explaining the adsorption of the lubricant agent. FIGS. 4A and 4B illustrate a magnetic recording medium 10 and a head slider 20 of a magnetic head that floats above the magnetic recording medium 10. In FIGS. 4A and 4B, the molecules of the lubricant agent applied on the surface of the magnetic recording medium 10 are indicated by a main chain 1 and an end group 2. FIG. 4A is an example of the lubricant agent having both end groups, illustrating a state where the molecules in which the end group is desorbed and adsorbed to the head slider 20 or both end groups desorbed on the magnetic recording medium 10 are adsorbed and aggregated at a portion that is free due to the desorption of one end group. FIG. 4B is an example of a lubricant agent having one end group, in which the molecules are similarly desorbed from the magnetic recording medium 10 and adsorbed to the head slider 20.

To avoid such a situation, it is known to arrange the adsorption group only on one side. Reference may be had to, for example, Y. Sakane et al., “Effect of modecularstructure of PFPE lubricant on interaction at HDI in near-contact operation”, IEEE Trans. Magn. Vol 0.42, pp 2501-2503. Such lubricant agent is stable when only one side of the molecule is adsorbed. The freed adsorption group does not adsorb to the head side, or does not become the core and form an aggregation of the lubricant agent as in the conventional lubricant agent since the adsorption group does not exist on the other side.

However, the conventional one end lubricant agent has a low adsorbability to the diamond like carbon (DLC) or a protective film of the magnetic head or the magnetic recording medium because the adsorption group is arranged on only one side. Due to the low adsorbability, the adsorbed portion may be desorbed by the bake process after the lubricant agent application, the heat in the drive, and the like. This reduces the film and causes the lubricating property to be unstable. Furthermore, in the heat assist recording, the conventional one end lubricant agent is most likely to be desorbed by heat.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view of a lubricant agent being absorbed according to an embodiment of the invention;

FIG. 2 is an exemplary view of a magnetic recording medium and a magnetic head coated with the lubricant agent in the embodiment;

FIG. 3 is an exemplary view of a magnetic storage device including the magnetic head and the magnetic recording medium coated with the lubricant agent in the embodiment; and

FIGS. 4A and 4B are exemplary schematic views of a conventional lubricant agent being absorbed.

### DETAILED DESCRIPTION

Various embodiments according to the invention will be described hereinafter with reference to the accompanying drawings. In general, according to one embodiment of the invention, a lubricant agent comprises a fluorine polymer represented as follows:

R¹—O—(R³O)l(R⁴O)m(R⁵O)n(R⁶O)o(R⁷)p-R²

where, R¹ is a perfluoroalkyl group of C1 to C10, R² is an organic group including at least one of three or more polar groups and carbon-carbon pi bonding, R³, R⁴, R⁵, and R⁶ are perfluoroalkylene groups of C1 to C4, respectively, R⁷ is an alkylene group or the perfluoroalkylene group of C1 to C10, and l, m, n, o, and p each indicate zero or a positive integer and do not concurrently indicate zero.

According to another embodiment of the invention, a magnetic storage device comprises a magnetic recording medium and a magnetic head. A lubricant agent is applied to at least one of a surface of the magnetic recording medium and the magnetic head. The lubricant agent comprises a fluorine polymer represented as follows:

R¹—O—(R³O)l(R⁴O)m(R⁵O)n(R⁶O)o(R⁷)p-R²

where, R¹ is a perfluoroalkyl group of C1 to C10, R² is an organic group including at least one of three or more polar groups and carbon-carbon pi bonding, R³, R⁴, R⁵, and R⁶ are perfluoroalkylene groups of C1 to C4, respectively, R⁷ is an alkylene group or the perfluoroalkylene group of C1 to C10, and l, m, n, o, and p each indicate zero or a positive integer and do not concurrently indicate zero.

In the Examples below, the number average molecular weight and the average of hydroxyl groups per molecule were measured with a nuclear magnetic resonance (NMR).

### Example 1

### First Lubricant Agent

First, 100 g of commercially available lubricant agent Demnum SA (product name, manufactured by DAIKIN INDUSTRIES, ltd., one hydroxyl group) and Glycidol (product name, manufactured by KANTO KAGAKU.) were dissolved, suspended, or formed to emulsion in an organic solvent (acetone), and stirred well. Thereafter, the agent was maintained at the temperature slightly higher than the boiling point of the solvent, and heated for about ten minutes. The aqueous solution in which 0.11 moL of sodium hydrate was dissolved in as small as possible amount of water was dropped into the agent for 15 minutes, and the resultant agent was heated and refluxed for six hours from the end of the dropping. Subsequently, the acetone was evaporated with an evaporator, and 25 g of trifluoroacetic acid and 250 mL of water were added to neutralize the sodium hydrate. Then, the resultant agent was stirred for three hours at 70° C. The sediments were then collected and cleaned with water at 80° C. The fluorine-containing polymer (unrefined product) expressed with formula (3) was thereby obtained.

Further, the sediments were dissolved and refined while the temperature and the pressure were changed using a supercritical fluid of carbon dioxide. Thus, a first lubricant agent, in which the number average molecular weight was 2200, the degree of dispersion was 1.25, and the average of hydroxyl groups per molecule were three, was obtained.

R¹—O—(R³O)l(R⁴O)m(R⁵O)n(R⁶O)o(R⁷)p-R² (1)

CF3CF₂CF₂O—(CF₂CF₂CF₂O)m-CF₂CF₂CH₂CH(OH)CH₂OCH₂CH(OH)CH₂OCH (3)

As an example in which R² of formula (1) is an organic group including three or more polar groups, a functional group including three hydroxyl groups expressed with formula (2) is contained. In this case, higher adsorbability can be applied through a simple preparation as described above.

—CH₂OCH₂CH(OH)CH₂OCH₂CH(OH)CH₂OH (2)

Three hydroxyl groups indicating high hydrogen bonding force are introduced and are each adsorbed to the medium surface by the hydrogen bonding force. Therefore, even if one or two hydroxyl groups are desorbed due to some kind of disturbance, the molecules of the lubricant agent are kept adsorbed to the substrate and are suppressed from becoming a free layer causing failures.

### Example 2

### Second Lubricant Agent

A commercially available lubricant agent Demnum SA (product name, manufactured by DAIKIN INDUSTRIES, ltd., one hydroxyl group) was diluted with a mixed solution of an equal amount of 1,1-dichloro-2,2,3,3,3-pentafluoropropane and 1,3-dichloro-1,1,2,2,3-pesitafluoropropane (AK-225, product name, manufactured by Asahi glass Co., Ltd.) and placed in four-mouthed flask attached with a reflux tower, a nitrogen bubbling tube, a stirring rod, and a dropping funnel. A dehydrating pyridine of a mol of three times with respect to the terminal hydroxyl group was added to the diluted lubricant agent, and the resultant agent was stirred while subjected to nitrogen bubbling at 50° C. Chloro-methylphenyl ethyl-dimethyl chlorosilane of a mol of three times the terminal hydroxyl group was diluted with AK-225 of double amount and dropped into the agent from the dropping funnel. The resultant agent was stirred for four hours at the temperature of 70° C. after the dropping to induce a silylation reaction.

Water washing was then performed until the reaction solution became neutral. Further, after cleaning twice with butyl acetate, the dissolved component was evaporated with a rotary evaporator and filtering was performed with a membrane filter of 0.1 μm.

The composition analysis was performed with the NMR to confirm that 98% of the hydroxyl group of the perfluoropolyether was silylated.

Further, the sediments were dissolved and refined while the temperature and the pressure were changed using a supercritical fluid of carbon dioxide. Thus, a second lubricant agent including chloromethyl phenylethyl group in which the number average molecular weight was 2300 and the degree of dispersion was 1.26 was obtained. Besides, the UV spectrum was measured and light adsorption at the wavelength of 254 nm was confirmed.

CF3CF₂CF₂O—(CF₂CF₂CF₂O)m—CF₂CF₂CH₂OSi(CH₃)₂CH₂CH₂PhCH₂Cl (4)

As an example in which R² of formula (1) is an organic group having carbon-carbon π bonding, an organic group may be preferably used that includes one of alkenyl group, aryl group, and aryl halide group.

Including the first and the second lubricant agents, the lubricant agent is preferably such that the number average molecular weight is from 500 to 5000, the degree of dispersion of the molecular weight is from 1.05 to 1.5, and the thermogravimetric reduction rate at 300° C. is smaller than or equal to 50%. This is a value that takes into consideration various usage environments and durable years of the magnetic storage device, and the trend of lower floating. The evaporation easily occurs if the molecular weight is smaller than this value since the interaction between the molecules is small. On the other hand, the molecules easily contact while the magnetic head is floating if the molecular weight is larger, which disturbs the stable floating. The margin of the floating property becomes narrow if the degree of dispersion is smaller than this value since the viscosity and other characteristics of the lubricant agent rapidly change due to the temperature and humidity. On the other hand, the evaporation of the small molecular weight component and the floating of the large molecular weight component are significantly affected if the degree of dispersion is larger. With regards to the heat resistance property, taking into consideration the margin of heat assist recording where heat resistance property stricter than the common magnetic storage device is required, the lubricant agent is exposed to instantaneous high temperature a number of times. Accordingly, the heat resistance property is severe when the thermogravimetric reduction rate at 280° C. is greater than or equal to 30% as an experimental indication.

The lubricant agent forms a lubricant film on the surfaces of the magnetic recording medium and the magnetic head, i.e., the surfaces brought into contact when actually used in the magnetic storage device, or the outermost surface of the magnetic recording medium or the magnetic head. This improves the floating property and enhances the reliability of the magnetic storage device. Preferably, the lubricant agent is applied to the outermost surface of both the magnetic recording medium and the magnetic head to further enhance the reliability.

### Example 3

### Thermal Characteristics of Lubricant Agent

As a result of performing thermal analysis on the commercially available lubricant agent, and the lubricant agents of Examples 1 and 2 to examine the thermogravimetric reduction at 300° C., it was confirmed that the thermogravimetric reduction was 95% for the commercially available lubricant agent and less than or equal to 30% for both the lubricant agents of Examples 1 and 2.

### Example 4

### Touch Down Characteristics of Lubricant Agent

The commercially available lubricant agent, and the lubricant agents of Examples 1 and 2 were coated on a magnetic recording medium and a magnetic head in a film thickness of eight angstroms each. Thereafter, the commercially available lubricant agent and the lubricant agent of example 1 were subjected to the bake process at 120° C. The lubricant agent of Example 2 was subjected to the irradiation process with a mercury lamp having a wavelength of 254 nm. With respect to pairs of a magnetic recording medium and a magnetic head using the respective lubricant agents, the magnetic head was controlled with a DFH mechanism, and the touch down/take-off hysteresis were measured. As a result, the magnitude of hysteresis was commercially available lubricant agent >>lubricant agent of Example 1≧lubricant agent of Example 2. Thus, it was confirmed that the floating margin in the lubricant agents of Examples 1 and 2 was higher than that in the commercially available lubricant agent.

Therefore, the bonding strength becomes higher by irradiating a light having a wavelength that adsorbs to the R² group after application of the lubricant agent, and forming a covalent bond between the R² group and the element of the applied surface, i.e., the carbon of the DLC. In the above case, the covalent bond is formed by irradiating an ultraviolet ray having a wavelength of 254 nm since the R² group is a chloromethyl phenylethyl group. If the R² group is a vinyl group or an allyl group, the covalent bond can be preferably formed by irradiating a light having a wavelength of 172 nm.

The film thickness of the lubricant agent on the magnetic recording medium and the magnetic head is 1.6 nm in accordance with the eight angstroms, but is generally preferably 0.5 to 2.0 nm (the sum when the lubricant agent is applied to both the magnetic recording medium and the magnetic head, or applied film thickness when the lubricant agent is applied to either the magnetic recording medium or the magnetic head). The lubricant agents exists in an island-form rather than as a film if the film thickness is thinner than such value and the lubricant agent thus cannot exhibit sufficient lubricating effect when contacted. Meanwhile, if the film thickness is thicker than such value, extra film thickness portion wastefully exists between the head and the medium, thereby inhibiting the magnetic spacing.

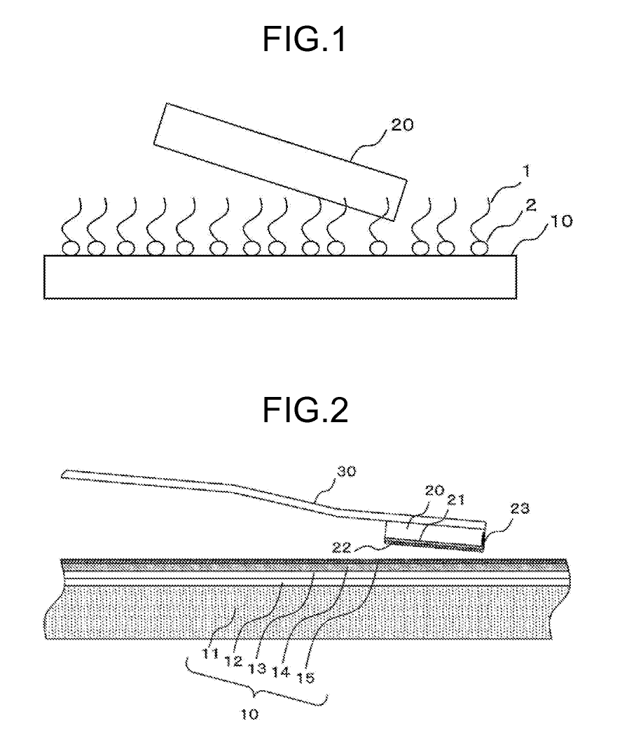

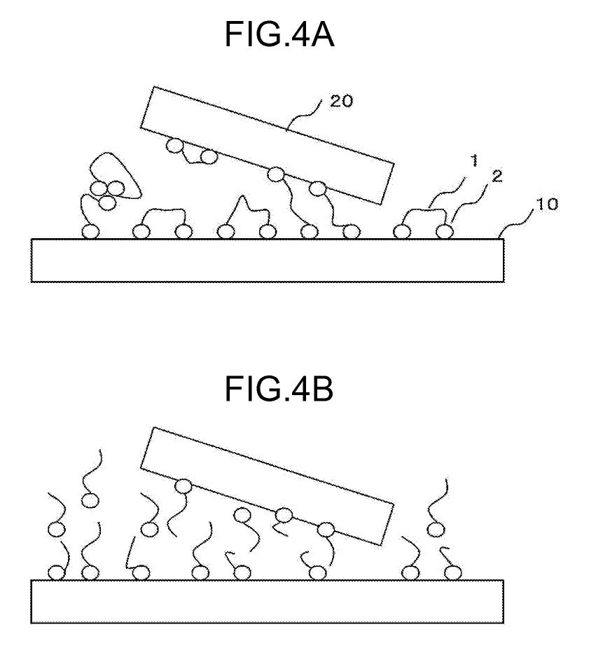

The adsorption state of the lubricant agent described above is illustrated in FIG. 1. FIG. 1 is a schematic diagram similar to FIGS. 4A and 4B illustrating the lubricant agent. As illustrated in FIG. 1, the lubricant agent is of one end group including three hydroxyl groups, and is strongly adsorbed on the magnetic recording medium 10.

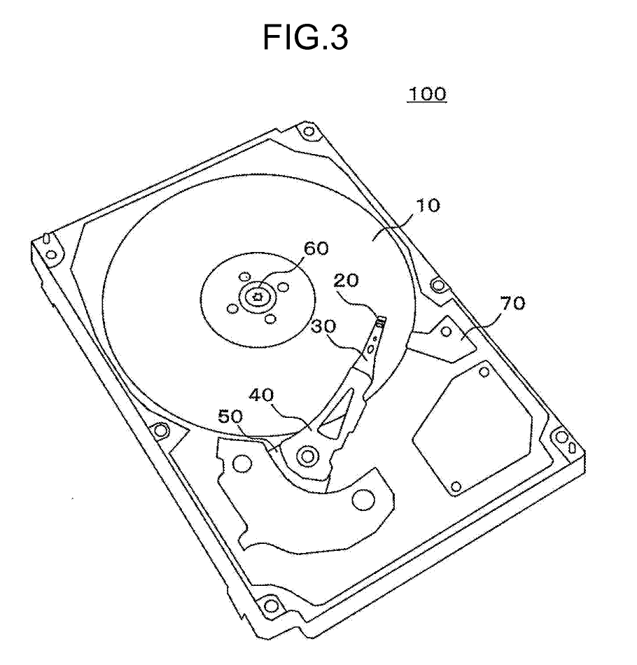

A description will be given of a magnetic storage device having a magnetic recording medium and a magnetic head coated with the lubricant agent mounted thereon. FIG. 2 is a cross-sectional view schematically illustrating the magnetic recording medium 10 and a magnetic head 23 coated with the lubricant agent. FIG. 3 is a perspective view schematically illustrating an internal structure of a magnetic storage device 100 having the magnetic recording medium 10 and the magnetic head 23 mounted thereon.

As illustrated in FIG. 2, the magnetic recording medium 10 comprises a base layer 12, a magnetic layer 13, a protective layer 14, and a lubricating layer 15 on a substrate 11. The respective materials are, for example, Cr or non-magnetic metal material having Cr as the main component for the base layer 12, Co alloy for the magnetic layer 13, the DLC for the protective layer 14, and the lubricant agent of Example 2 for the lubricating layer 15.

The magnetic head 23 is formed on the head slider 20, and a protective layer 21 and a lubricating layer 22 are formed on a floating surface of the head slider 20 facing the magnetic recording medium 10. The protective layer 21 may be the DLC, and the lubricating layer 22 may be the lubricant agent of Example 2. The film thickness of a combination of the lubricating layer 15 and the lubricating layer 22 is 1.6 nm, and the ultraviolet ray having a wavelength of 254 nm is irradiated after the lubricant agent is applied.

FIG. 3 illustrates the overall structure with the upper cover of the housing of the magnetic storage device 100 removed. The magnetic recording medium 10 described in FIG. 2 is fixed to a rotation shaft 60 of a spindle motor (not illustrated) to rotate by such spindle motor. The head slider 20 is attached to the end of a suspension 30 (more specifically, fixed to a gimbal (not illustrated) at the end of the suspension 30). A head arm 40 is attached to the other end of the suspension 30. The head arm 40 is attached to an actuator 50 rotatably supported by a base plate of the magnetic storage device 100.

When the magnetic recording medium 10 rotates by the spindle motor, an air flow is generated with the rotation, and the head slider 20 floats above the magnetic recording medium 10 due to the air flow. The DFH control, described above, is performed when the magnetic head 23 first floats to above the magnetic recording medium 10 from a lamp 70 where it is in standby at the time of non-access. The floating height during floating is controlled using a piezoelectric actuator, a thermal actuator, or the like. The position of the magnetic head 23 on the magnetic recording medium 10 is controlled by controlling the rotation angle of the actuator 50.

As described above, according to an embodiment of the invention, the lubricant agent is effectively used in the magnetic storage device having a mechanism configured to control the gap (i.e., magnetic spacing) between the magnetic recording medium and the magnetic head, and a mechanism in which the magnetic recording medium and the magnetic head contact in a non-stationary state. While the magnetic head 23 is described above as reading or writing data by floating above the magnetic recording medium 10, this is by way of example only. The magnetic head 23 may read or write data while contacting the magnetic recording medium 10.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lubricant agent comprising a fluorine polymer represented as follows:
R¹—O—(R³O)l(R⁴O)m(R⁵O)n(R⁶O)o(R⁷)p-R²
where, R¹ is a perfluoroalkyl group of C1 to C10, R² is an organic group including at least one of three or more polar groups and carbon-carbon pi bonding, R³, R⁴, R⁵, and R⁶ are perfluoroalkylene groups of C1 to C4, respectively, R⁷ is an alkylene group or the perfluoroalkylene group of C1 to C10, and l, m, n, o, and p each indicate zero or a positive integer and do not concurrently indicate zero.

2. The lubricant agent of claim 1, wherein the R² is represented as follows:
—CH₂OCH₂CH(OH)CH₂OCH₂CH(OH)CH₂OH.

3. The lubricant agent of claim 1, wherein the R² contains an organic group containing an aryl halide group.

4. The lubricant agent of claim 1, wherein a number average molecular weight is 500 to 5000, a molecular weight dispersion degree is 1.05 to 1.5, and a thermogravimetric reduction rate at 300° C. is less than or equal to 50%.

5. A magnetic storage device comprising
a magnetic recording medium; and
a magnetic head, wherein
a lubricant agent is applied to at least one of a surface of the magnetic recording medium and the magnetic head, and
the lubricant agent comprises a fluorine polymer represented as follows:
R¹—O—(R³O)l(R⁴O)m(R⁵O)n(R⁶O)o(R⁷)p-R²
where, R¹ is a perfluoroalkyl group of C1 to C10, R² is an organic group including at least one of three or more polar groups and carbon-carbon pi bonding, R³, R⁴, R⁵, and R⁶ are perfluoroalkylene groups of C1 to C4, respectively, R⁷ is an alkylene group or the perfluoroalkylene group of C1 to C10, and l, m, n, o, and p each indicate zero or a positive integer and do not concurrently indicate zero.

6. The magnetic storage device of claim 5, wherein light having a wavelength that adsorbs to the R² group is irradiated after application of the lubricant agent to form covalent bonding between the R² group and elements of the surface coated with the lubricant agent.

7. The magnetic storage device of claim 5, wherein a total film thicknesses of the lubricant agent applied to at least one of the magnetic recording medium and the magnetic head is 0.5 to 2.0 nm.

8. The magnetic storage device of claim 5, further comprising:
a mechanism configured to control a gap between the magnetic recording medium and the magnetic head; and
a mechanism in which the magnetic recording medium and the magnetic head contact in a non-stationary state.
